(19) United States
(12) Patent Application Publication
(10) Pub. No.: US 2015/0156998 A1
(43) Pub. Date: Jun. 11, 2015

(54) SYSTEM, METHOD, AND PLATFORM FOR REMOTE SENSING AND DEVICE MANIPULATION IN FISHING ENVIRONMENTS

(71) Applicant: Smart Catch LLC, Palo Alto, CA (US)

(72) Inventor: Robert Mark Terry, Palo Alto, CA (US)

(21) Appl. No.: 14/341,606

(22) Filed: Jul. 25, 2014

Related U.S. Application Data
(60) Provisional application No. 61/913,888, filed on Dec. 9, 2013.

(51) Int. Cl. A01K 75/00

(52) U.S. Cl. CPC A01K 75/00

(57) ABSTRACT

Described is a system, method, and platform for monitoring fishing environments and controlling devices associated therewith. A system includes a sensing array that comprises one or more sensors generating sensor data pertaining to environment characteristics of a fishing environment. Also included is a bidirectional communication subsystem to transmit the sensor data to a data processing device and transmit a control signal from the data processing device to the sensing array. A platform includes a data processing device, one or more controllers, and one or more sensors. The data processing device includes a processor configured to execute a plugin application bundle, a SaaS bundle, and an API bundle. Sensor data generated by the sensor(s) may be encrypted and stored in a secure cloud storage to be utilized by the plugin application bundle and the SaaS bundle. Based on the sensor data, the platform may manipulate devices associated with the platform.

### CLAIM OF PRIORITY

This application claims priority to U.S. Provisional Patent Application Ser. No. 61/913,888, filed Dec. 9, 2013, the entire disclosure of which is hereby expressly incorporated by reference herein.

### FIELD OF TECHNOLOGY

This disclosure relates generally to an expandable platform, and more specifically, to systems and methods for remotely monitoring fishing environments and controlling devices associated therewith.

### BACKGROUND

When commercial fishing vessels cast their nets into the water, the contents of their nets may remain a mystery until the catch is brought out of the water and onto the deck. Oftentimes, the catch may consist of out-of-season, endangered, and/or juvenile fish that fishermen may not be able to sell (also called “bycatch”). In worse situations, the fishermen may even be fined or may be forced to shut down the entire fishery due to exceeding fishery quotas. Due to the nature of trawl nets, the out-of-season fish may perish before they are even brought to the surface for identification. Furthermore, there may be a chance that the nets catch few or no fish at all. This inefficient fishing method may lead to inordinate expenditures of time yielding little to no profit. Furthermore, this method may also negatively impact the ocean environment by diminishing fish species diversity. The ecological impact of this fishing method may involve reductions in the volume of future catches, drastic changes to coastal populations that subsist or otherwise depend on stable fish populations, and the overall endangerment of aquatic ecosystems.

Commercial fishing systems do not currently provide a means for inspection of their trawl nets or fishing pots during harvest. The ability to inspect the catch in real-time would vastly improve the efficiency of fishing methods which are currently performed blindly (e.g. the trawl net is cast underwater and pulled out after a length of time has passed to determine what, if anything, is caught). Furthermore, current solutions do not provide a facility to manipulate the capture method in order to release or dynamically divert unwanted catches of non-target species.

Aquaculture farming systems do not currently possess a means for large scale evidence-based inspection and amalgamation of key metrics involved in determining and regulating the living conditions of aquaculture organisms. Regulatory organizations may impose stringent compliance demands that may be difficult to consistently test for and meet. Certain key metrics (e.g. type and degree of antibiotic use, chemical concentrations, disease detection, crowding (biomass density), etc.) may be routinely measured, though standards may not be consistently followed. As such, collected data may have ambiguous credibility, which may lead to inferior aquaculture environment conditions and subsequently to lower quality product and loss of marine life. Furthermore, aquaculture farming systems may not possess means for predator abatement and theft deterrence, both of which pose a risk to marine life as well as to the economic stability of the aquaculture operation.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic diagram of an expandable platform for remote sensing and device manipulation in fishing environments, according to one or more embodiments.

FIG. 2 is a schematic diagram of an underwater harvesting device comprising a sensing array communicatively coupled to a data processing device of a fishing vessel, according to one or more embodiments.

FIG. 3 is a component view of the exemplary configuration of FIG. 2, specifically of the data processing device and the sensing array, according to one or more embodiments.

FIG. 4A is a schematic diagram of a fishing vessel establishing a connection to a network through a cellular tower, according to one or more embodiments.

FIG. 4B is a schematic diagram of a fishing vessel establishing a connection to a network through a satellite, according to one or more embodiments.

FIG. 5A is a schematic diagram of a sensing array monitoring a seine net, according to one or more embodiments.

FIG. 5B is a schematic diagram of a sensing array monitoring a fishing pot, according to one or more embodiments.

FIG. 5C is a schematic diagram of a sensing array mounted to a trawl net underwater harvesting device, according to one or more embodiments.

FIG. 5D is a schematic diagram of a remotely operated vehicle (ROV) coupled to a sensing array monitoring a seine net, according to one or more embodiments.

FIG. 5E is a schematic diagram of a plurality of sensing arrays coupled to a trawl net, according to one or more embodiments.

FIG. 6 is a schematic diagram of a sensing array coupled to a ballast jacket.

FIG. 7 is a schematic diagram of an aquaculture management platform and a device hierarchy thereof, according to one or more embodiments.

FIG. 8A shows a structure of a data processing device, according to one or more embodiments.

FIG. 8B shows a structure of a computing platform, according to one or more embodiments.

FIG. 9 is a process flow chart of a feedback system involving monitoring of a harvesting device and manipulating one or more electro-mechanical features of a sensing array and/or the harvesting device, according to one or more embodiments.

FIG. 10 is a process flow chart of a feedback system involving monitoring and sampling a fishing environment and manipulating one or more electro-mechanical features of an underwater or above-water sensing array, according to one or more embodiments.

Other features of the present embodiments will be apparent from the accompanying drawings and from the detailed description that follows.

### SUMMARY

Disclosed are systems, methods, and platforms for remotely monitoring fishing environments and controlling devices associated therewith.

In one aspect, a fishing system includes a sensing array that comprises one or more sensors. The sensor(s) generate sensor data pertaining to one or more environmental characteristics associated with a fishing environment. The system further includes one or more electronic devices and one or more electromechanical devices, both of which are coupled to the sensing array. Furthermore, the fishing system includes a bidirectional communication subsystem configured to: transmit the sensor data from the sensing arrays to be stored in a memory of a data processing device; and transmit, based on the sensor data, a control signal from the data processing device to the sensing array to manipulate one or more electromechanical features associated with at least one of the one or more electronic devices and the one or more electromechanical devices.

In another aspect, a method of precision fishing involves generating sensor data through one or more sensors of a sensing array associated with a fishing environment. The sensor data pertains to one or more environmental characteristics of the fishing environment. The method also involves transmitting the sensor data from the sensing array to a data processing device communicatively coupled to the sensing array through a bidirectional communication subsystem. The method further involves storing the sensor data in a memory of the data processing device. The method also involves transmitting, based on the sensor data, a control signal through the bidirectional communication subsystem to a controller of the sensing array to manipulate a feature of at least one of: the sensor(s), one or more electronic devices coupled to the controller, and one or more electromechanical devices coupled to the controller. The electronic device(s) and the electromechanical device(s) are associated with the fishing environment.

In yet another aspect, a platform for precision fishing includes a data processing device. The data processing device comprises a memory and a processor. The processor is configured to execute an operating system that: facilitates a plug-in application bundle and a service-as-a-software (SaaS) bundle, and supports an application programming interface (API) bundle. The platform also includes one or more controllers communicatively coupled to the data processing device and configured to enable bidirectional transmission of data, through one or more control protocols, between one or more electromechanical devices and the processor. The one or more electromechanical devices are associated with a fishing environment and are communicatively coupled to the processor through a plug-in interface of the one or more controllers. The platform also includes one or more sensor(s) that are communicatively coupled to the processor through the plug-in interface of the data processing device. The one or more sensor(s) generate sensor data pertaining to one or more environmental characteristics of the fishing environment.

### DETAILED DESCRIPTION

Disclosed are systems, methods, and/or platforms to monitor and/or control underwater components through a data processing device. Although the present embodiments have been described with reference to specific example embodiments, it will be evident that various modifications and changes may be made to these embodiments without departing from the broader spirit and scope of the various embodiments.

Moreover, the components shown in the figures, their connections, couplings, relationships, and functions are meant to be exemplary only, and are not meant to limit the embodiments described herein. Also, it may be noted that the communicative coupling of devices may be through a wired means, a wireless means, or a combination thereof.

The exemplary embodiments discussed below disclose a modular, expandable, plug-and-play platform comprising a host of utilities for monitoring and manipulating underwater harvesting devices and contents thereof. Underwater harvesting devices may include trawl nets, pots, gill-nets, seine nets, and long lines. A trawl net may be a harvesting method involving pulling a net behind one or more fishing vessels. A seine net may be a net that is positioned vertically in the water with its bottom edge held down by weights and its top edge buoyed by floats. Long line fishing may involve utilizing a main line and a plurality of branch lines with baited hooks attached at regular intervals on the branch lines. Other harvesting methods are within the scope of the exemplary embodiments discussed herein. The system may include aspects of video monitoring, device state feedback, data sensors for information acquisition (e.g. live fish counting, length, shape, and fish identification systems), outgoing data communication, and a universal interface for expanding the platform to provide support for future software functionalities as well as additional devices and sensors.

The term “module” used herein may refer to software, hardware, or a combination thereof. For example, the software may be machine code, firmware, embedded code, application software, or a combination thereof. In addition, the hardware may be implemented as mechanical devices, integrated circuits, micro-electromechanical systems (MEMS), sensors, passive devices, optical filters, plug-and-play devices, or a combination thereof.

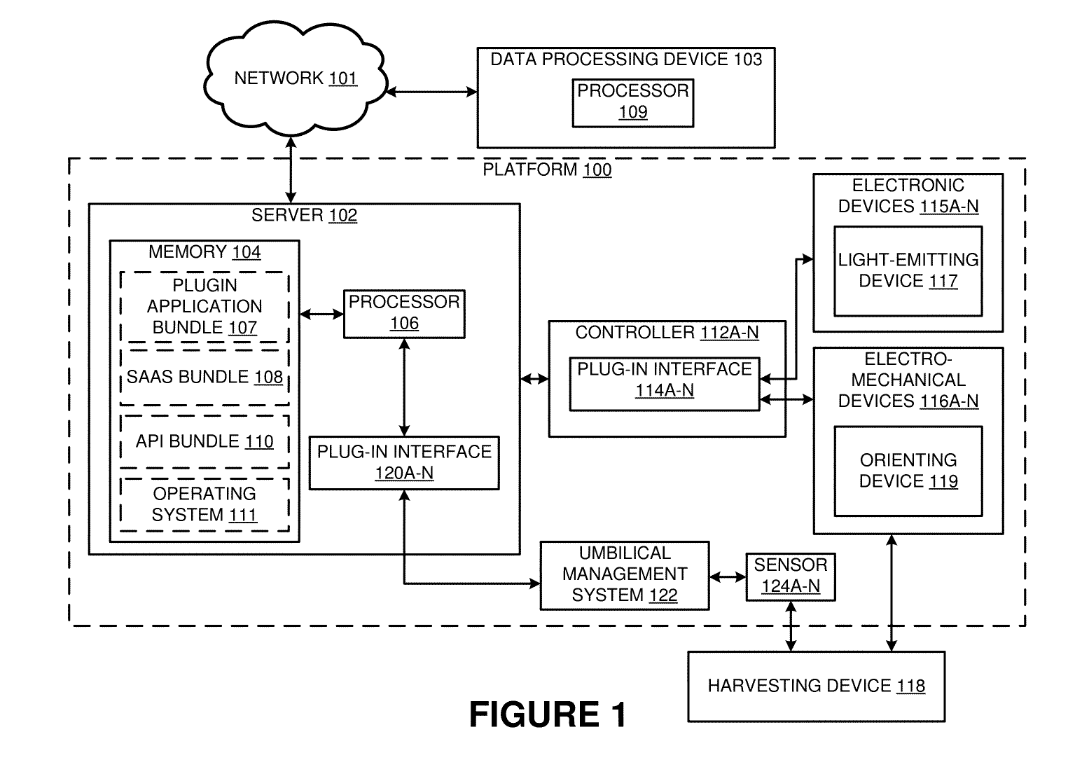

Reference is now made to FIG. 1, a schematic diagram of an expandable platform for remote sensing and device manipulation in fishing environments. The platform may be “expandable” in that it can support any number and type of plug-in modules. A platform 100 may be a computing environment employing software and hardware components. The platform 100 may enable bidirectional communication between surface and underwater devices directly through a wireless and/or wired means and/or indirectly through a network interface. The platform 100 includes a server 102. The server 102 includes a memory 104 and a processor 106 (e.g. a CPU or a GPU). The processor 106 is configured to execute an operating system 111 facilitating a plugin application bundle 107, a SaaS bundle 108, and an application programming interface (API) bundle 110.

The server 102 may be communicatively coupled to a network 101. The network 101 may be a Local Area Network (LAN), a Wide Area Network (WAN) such as the World Wide Web (WWW), an intranet of data processing devices having access to the WWW, or an extranet of data processing devices having no access to the WWW. The server 102 may be communicatively coupled to a data processing device 103 through the network 101. The plugin application bundle 107, the SaaS bundle 108, and the API bundle 110 may also be stored in a memory 109 of the data processing device 103 and may be executed by a processor 106 of the server 102.

The SaaS bundle 108 may comprise software instructions stored in memory 104 and executed by processor 106, the output of which may be communicated to the data processing device 103 through the network 101 and viewed through a browser or through a plugin application executed by the data processing device 103. As such, the server 102 may be part of a cloud facility that provides a plurality of SaaS through the network 101.

In one embodiment, SaaS bundle 108 may provide surveillance management and teleoperation accessibility software as a service to data processing device 103. In another embodiment, SaaS bundle 108 may provide a trade route tracking and analysis software as a service to data processing device 103. In yet another embodiment, the SaaS bundle 108 may provide image recognition and object detection software as a service to data processing device 103. In another embodiment, the SaaS bundle 108 may provide secure cloud storage software as a service to data processing device 103. Alternatively, the software services described herein may be provided by a plugin application bundle 107 of the server 102 or may be stored as plugin applications in the memory 109. Other types and forms of SaaS may be deployed through the platform and provided to data processing device 103 and may be within the scope of the exemplary embodiments discussed herein.

The API bundle 110 may constitute one or more libraries comprising specifications for routines, data structures, object classes, variables, and/or remote calls for facilitating graphical user interface (GUI) components, accessing databases and hardware, and providing translational protocols between differing programming languages, operating systems, etc. Other forms and functions of the API bundle 110 may be within the scope of the exemplary embodiments discussed herein.

The server 102 may be communicatively coupled to one or more controller(s) 112A-N. A controller may be a stand-alone or integrated circuit and may interface with coupled peripheral devices. In one embodiment, the controller(s) 112A-N may be communicatively coupled to one or more electronic device(s) 115A-N and one or more electro-mechanical device(s) 116A-N through at least one plug-in interface 114A-N. The plug-in interface(s) 114A-N may support coupling of any number and type of electronic devices 115A-N and electro-mechanical device(s) 116A-N. An electronic device may be any device that employs an application-specific integrated circuit (ASIC) or integrated circuit (IC) to perform a specific function. For example, an electronic device may be a light-emitting device and may emit light of any wavelength. An electro-mechanical device may be any device that employs an IC and/or a mechanical component to perform a specific function. In another embodiment, an electro-mechanical device may be an orienting device for rotating or translating a coupled device through the use of one or more servos. Other types of electronic device(s) 115A-N and electro-mechanical device(s) 116A-N may be within the scope of the exemplary embodiments discussed herein.

The platform 100 may further comprise an umbilical management system 122, in which “umbilical” may refer to any system or device associated with communication between underwater components and surface components. The umbilical management system 122 may facilitate a communicative coupling between a plug-in interface 120A-N of the server 102 and one or more sensors 124A-N. The server 102 may also be communicatively coupled to one or more sensors 124A-N through one or more plug-in interfaces 120A-N. The umbilical management system 122 may comprise any number and type of interconnection (e.g. VDSL coaxial cable, ethernet cable, wireless router(s), wireless access points, etc.) and may be a communicative conduit between the server 102 and the sensor(s) 124A-N. The plug-in interface(s) 120A-N may support coupling of any number and type of sensor(s) 124A-N through the umbilical management system 122.

A sensor may be any device that measures a sensory input (e.g. sound, video, humidity, pressure, temperature, salinity, infrared light, etc.) and records and/or communicates the sensory input to the server 102. In one embodiment, the sensor(s) 124A-N may be video camera devices and may record and transmit video in real-time to the server 102 and subsequently to the data processing device 103 through the network 101. In another embodiment, the sensor(s) 124A-N may include a temperature sensor and may measure environmental temperature data and transmit the same to the server 102 and subsequently to the data processing device 103 through the network 101. In yet another embodiment, the sensor(s) 124A-N may be a humidity and/or pressure sensor embedded within an underwater device in order to detect water leakage. Other types of sensors 124A-N may be within the scope of the exemplary embodiments discussed herein.

The electronic device(s) 115A-N, the electro-mechanical device(s) 116A-N, and the sensor(s) 124A-N may be associated with a harvesting device 118. The electronic device(s) 115A-N may sample the fishing environment for one or more biometrics or illuminate an area for recording by video camera device(s). The electro-mechanical device(s) 116A-N may physically manipulate the harvesting device 118 or may facilitate the usage of the sensor(s) 124A-N. In one embodiment, an electronic device(s) 115A-N may be a light-emitting device 117 and may be used in concert with a video camera device to record video data of the illuminated contents of the harvesting device 118. In one embodiment, an electro-mechanical device 116A-N may be an orienting device 119 and may rotate and/or manipulate a position of a coupled device (e.g. light-emitting device 117 or a video camera device). The sensor(s) 124A-N may collect data pertaining to the harvesting device 118 and may transmit the data to the data processing device 103. Such data may include video stream data (e.g. monitoring the contents of the harvesting device 118), sound data, pressure data, sonar data, etc.

The data processing device 103 may be communicatively coupled to a network 101 through which a connection to the WWW and/or an intranet may be established. The SaaS bundle 108 may be communicated securely through the network 101 from a cloud facility or through a host server on the intranet.

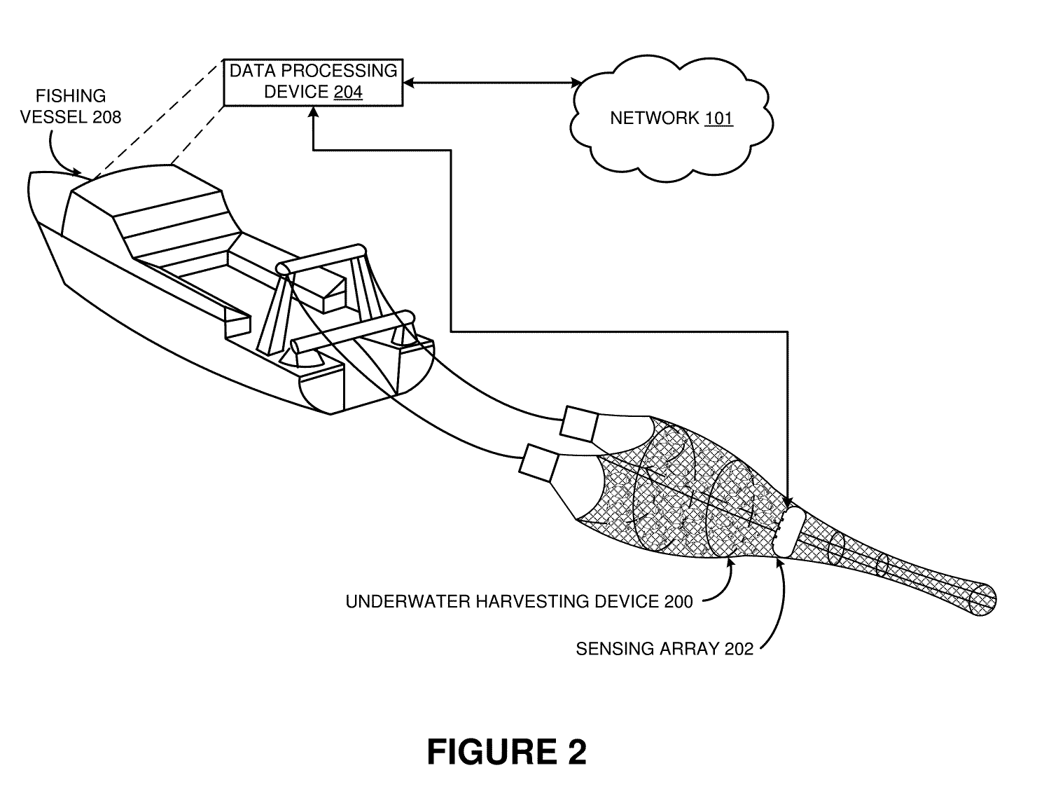

Reference is now made to FIG. 2, a schematic diagram of an underwater harvesting device comprising a sensing array communicatively coupled to a data processing device of a fishing vessel, according to one or more embodiments. The underwater harvesting device 200 may be coupled to the fishing vessel 208. The underwater harvesting device 200 may constitute any method of harvesting marine organisms such as a trawl net (as shown in FIG. 2), a crab pot, a seine net, etc. Underwater harvesting devices that employ other underwater harvesting methods may be within the scope of the exemplary embodiments discussed herein.

A sensing array 202 may be associated with the underwater harvesting device 200 and may be communicatively coupled to a data processing device 204. In one embodiment, the sensing array 202 may be a watertight device comprising a plurality of modules for facilitating underwater monitoring as well as wireless and/or wired bi-directional communication to underwater devices communicatively coupled to the sensing array 202. In another embodiment, the sensing array 202 may be a collective term describing a plurality of networked, pressure-compliant, watertight (depth and/or pressure-rated) devices comprising a plurality of modules for facilitating underwater monitoring as well as wireless and/or wired bi-directional communication to underwater devices. The fishing vessel 208 may represent any movable or immovable, floating vessel.

The sensing array 202 may be mounted to a tow wing coupled to the fishing vessel 208. A tow-wing may be an apparatus assembled in such a way as to provide smooth fluid dynamics when submerged and towed by the fishing vessel 208. As such, the sensing array 202 coupled to the tow wing may allow the sensing array 202 to stay submerged during towing.

The data processing device 204 may be communicatively coupled to a network 206 and may subsequently communicate with server 102 through the network 206. The data processing device 204 may enable a user to monitor and/or manipulate features of the sensing array 202 and any devices coupled thereto.

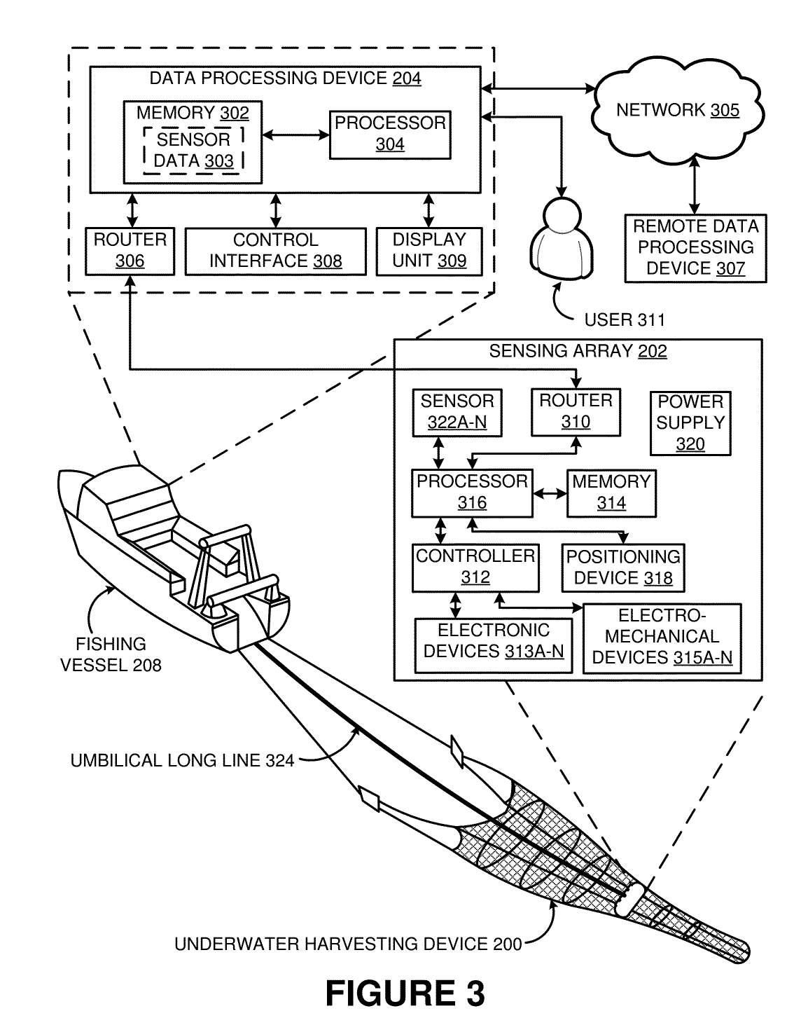

Reference is now made to FIG. 3, a component view of the exemplary configuration of FIG. 2, according to one or more embodiments. The data processing device 204 may comprise a memory 302 and a processor 304. The data processing device 204 may be communicatively coupled to a router 306 and a control interface 308.

A control interface 308 may be a physical device that may provide an interactive interface for manipulating a function of another device. For example, a control interface may be a joystick supporting movement in at least one axis; such a control interface may enable fine control over a servo or a motor of a mechanical device. Another example of a control interface may be a rotating control knob; such a control interface may be used in concert with a light-emitting device to provide fine control over the intensity of light or the wavelength of light. Other types of control interfaces and applications thereof are within the scope of the exemplary embodiments discussed herein.

The data processing device 204 may be communicatively coupled to other data processing devices through the router 306. The data processing device 204 and other devices networked through the router 306 may be communicatively coupled to the sensing array 202 through an umbilical long line 324 and/or through a wireless network connection between router 306 and router 310 of the sensing array 202. The router 306, router 310 and the umbilical long line 324 may be constituents of an underwater-surface communication system that facilitates bi-directional transmission of data between the data processing device 204 and the sensing array 202.

The umbilical long line 324 may be a watertight interconnect system that may facilitate communication between underwater components (e.g. sensing array 202, components thereof, and/or components coupled thereto) and surface components (e.g. data processing device 204) of the fishing system. The umbilical long line 324 may comprise any number and type of interconnection methods (e.g. VDSL coaxial cable, ethernet cable, wireless router(s), wireless access points, etc.) and may be a communicative conduit between the data processing device 204 and the sensing array 202.

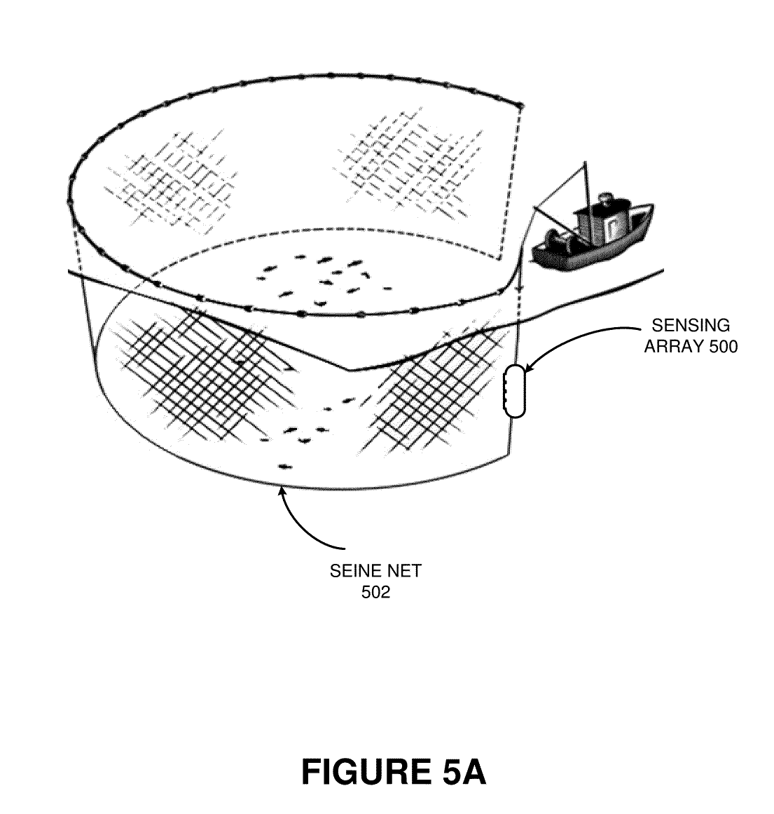

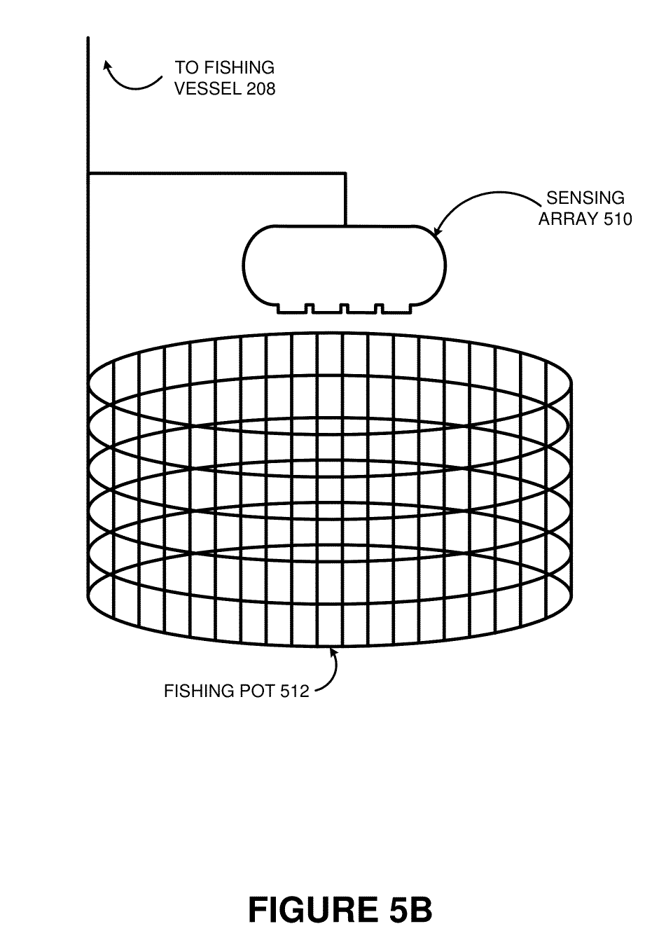

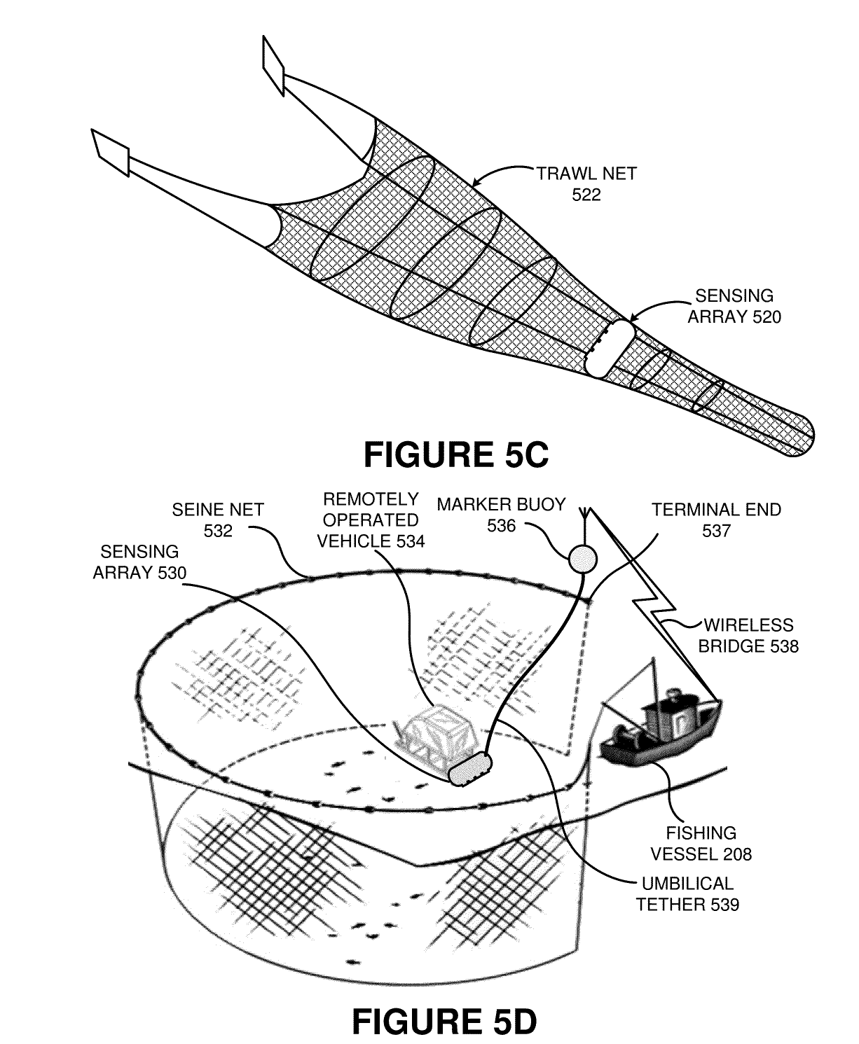

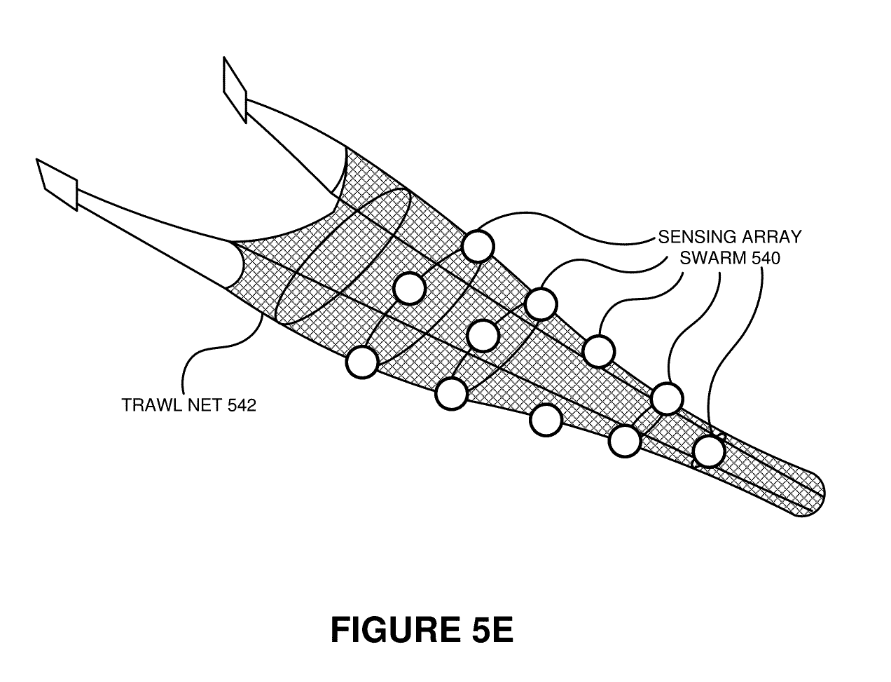

The sensing array 202 may be coupled to the underwater harvesting device 200. In the trawl-net embodiment of FIG. 2, the sensing array 202 may be positioned at the anterior of the catch-end of the trawl net, as shown in FIG. 5C. Such positioning may enable monitoring and/or identification of fish before reaching the catch-end, where fish usually remain until the trawl net is pulled out of the water and back to the fishing vessel 208. The sensing array 202 may comprise a memory 314; the memory 314 may be a volatile and/or a non-volatile memory. The sensing array 202 may further comprise a processor 316 (e.g. a CPU or a GPU) to which the router 310, a controller 312, a positioning device 318, and one or more sensors 322A-N may be coupled. These components of the sensing array 202 may be powered through a power supply 320.

The processor 304 may be configured to transmit a control signal to the controller 312 through the fishing system. The control signal may manipulate a device (e.g. electronic device(s) 313A-N, electro-mechanical device(s) 315A-N) coupled to the controller 312. For example, a control signal may be transmitted to the controller 312 to manipulate operation of a light-emitting device coupled to the controller 312. A further control signal may be transmitted to the controller 312 to increase intensity and/or alter the wavelength of the light-emitting device. In another example, one or more control signals may be transmitted to the controller 312 to manipulate operation of a positioning device 318 coupled to a light-emitting device, allowing a repositioning of a beam of light.

In another example, a control signal may be transmitted to the controller 312 to initiate or halt operation of a video camera device. Operation of the video camera device may adhere to standardized industry pan/tilt/zoom (PTZ) protocols, such as Pelco-D. Other operations of the camera device (e.g. changing exposure, aperture, optical zoom, etc.) and protocols are within the scope of the exemplary embodiments.

In one embodiment, the sensor(s) 322A-N may be configured by the processor 316 to generate sensor data 303 (e.g. video stream data, temperature data, humidity data, sonar data, pressure data, salinity data, diluted oxygen (DO) concentration data, nitrogen concentration data, etc.), which may be transmitted to the data processing device 204 by the processor 316. A user 311 may subsequently view the sensor data 303 through a display unit 309 (e.g. LCD, LED, CRT) of the data processing device 204. The processor 316 may be configured to transmit the sensor data 303 to the data processing device 204 through the wireless connection between the router 306 and the router 310. Alternately, the sensor data 303 may be transmitted through the umbilical long line 324. The sensor data 303 may be stored in the memory 302 or may be subsequently transmitted to a remote data processing device 307 that may be communicatively coupled to the data processing device 204 through a network 305. Based on the transmitted sensor data 303, one or more control signals may be transmitted to the sensing array 202 to manipulate one or more features of the sensor(s) 322A-N, one or more electronic devices 313A-N coupled to the controller 312, and/or one or more electro-mechanical devices 315A-N coupled to the controller 312.

Furthermore, the sensor data 303 may be appended with descriptive metadata generated based on predetermined algorithms or manually by a user of the data processing device 204. The metadata may comprise textual data (e.g. comments, descriptions), temporal data (e.g. timestamp), and/or geospatial coordinates. For example, a user 311 of the data processing device 204 viewing the sensor data 303 may be desirous of supplementing the data with relevant metadata. Furthermore, individual video data streams may be associated with individual sensor data streams corresponding to sensors 322A-N that may gather sensor data 303 in the vicinity of the sensors 322A-N. Other types of metadata may be within the scope of the exemplary embodiments discussed herein.

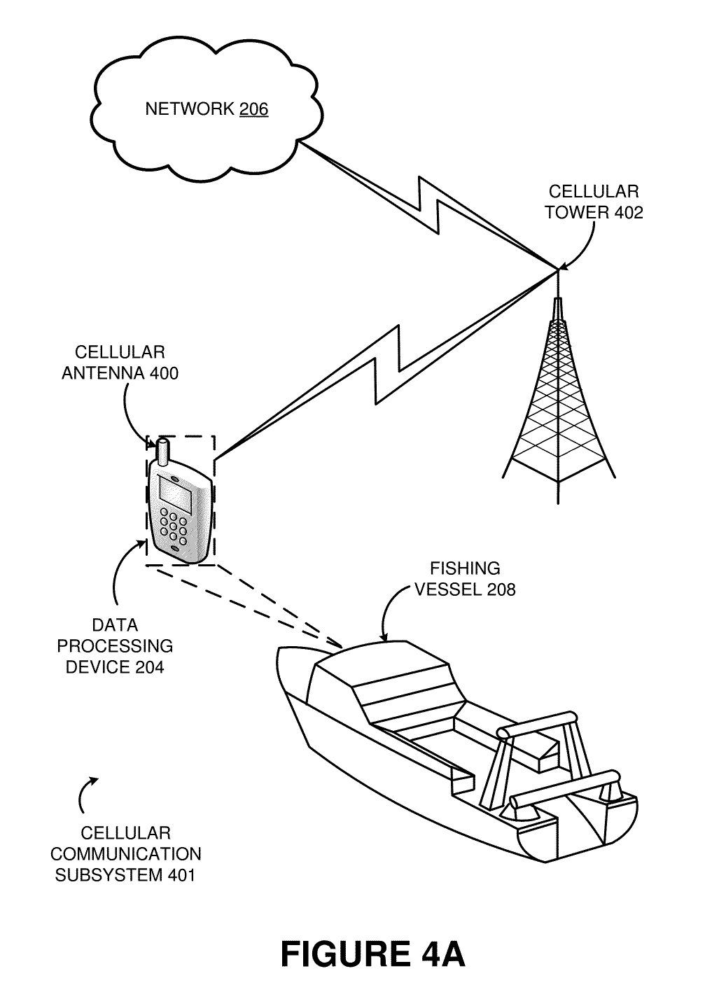

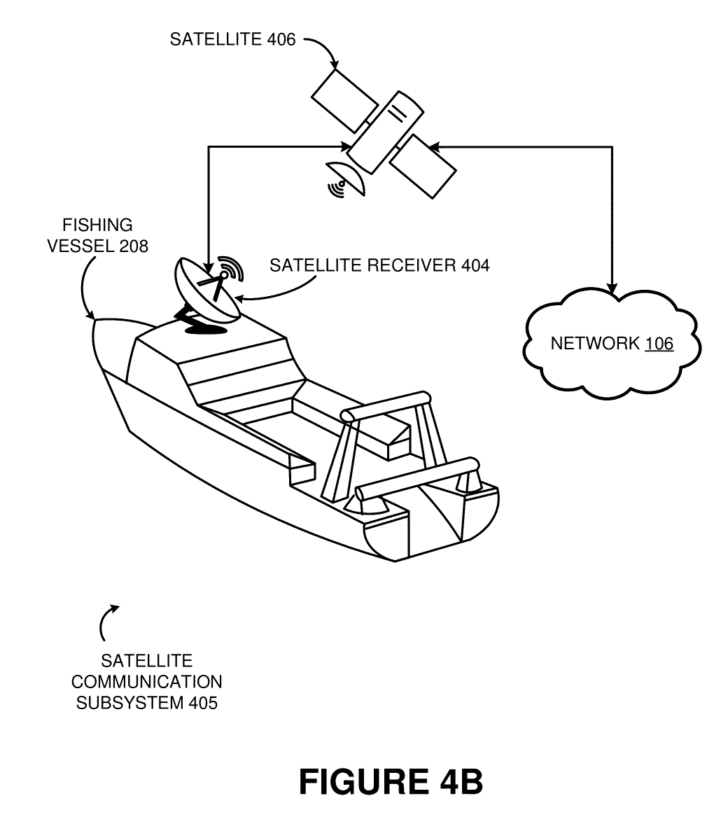

In one embodiment, the fishing vessel 208 may be one of a plurality of fishing vessels. Each of the one or more fishing vessels may be analogous to the fishing vessel 208 in that they comprise an underwater harvesting device 200, a sensing array 202 associated therewith, and a data processing device 204. Reference is now made to FIGS. 4A-B, which are schematic diagrams of the fishing vessel 208 of FIG. 2 establishing a network through a cellular tower (FIG. 4A) and/or a satellite (FIG. 4B), according to one or more embodiments.

In one embodiment, the fishing vessel 208 may be part of a fleet of fishing vessels. In one embodiment, each of the fishing vessels of a fleet of fishing vessels may comprise a cellular antenna 400 and/or a satellite receiver 404. Other wireless communication (e.g. WiFi™ Bluetooth, radio frequency (RF), infrared (IR), etc.) may also be used and may be within the scope of the exemplary embodiments discussed herein. In one embodiment, a cellular communication subsystem 401 comprises a cellular antenna 400 which may communicate to a network 206 through a cellular tower 402 (e.g., via CDMA, GSM, TDMA, WCDMA, GPRS, etc.). In another embodiment, a satellite communication subsystem may comprise a satellite receiver 404 that may send/receive communications to the network 206 through a satellite 406. In one embodiment, through an established connection to the network 206 through the cellular antenna 400 and/or the satellite receiver 404, the one or more fishing vessels may constitute an intranet of fishing vessels that may be facilitated by the WWW or another internet protocol. The network connection may be established through an encrypted protocol (e.g. SSH, SSL, etc.). In another embodiment, the one or more fishing vessels may constitute an extranet of fishing vessels that is not facilitated by the WWW (e.g. the network connection is established through an internet protocol outside of the WWW).

All components of the platform 100 may be polled in order to determine an individual or aggregated operational status. Components that may be polled include the sensing array 202, the data processing device 204, the umbilical management system 122, the cellular communication subsystem 401, the satellite communication subsystem 405, and all sub-components thereof. Other components that may be plugged into the platform 100 may also be polled for an operational status and may be within the scope of the exemplary embodiments discussed herein.

In one embodiment, a network employing an encrypted protocol may provide a hierarchy of privilege-based access to other data processing devices on the network. For example, a fishing team onboard a fishing vessel may comprise a captain, a first mate, and other deckhands. A data processing device of the captain may have unrestricted access to all features of the fishing vessel's sensing array as well as unrestricted access to the intranet of fishing vessels. For example, the captain may access any fishing vessel in the fleet to: reorient a video camera device of the sensing array, initiate/halt operation of the video camera device, toggle operation of light emitting devices of the sensing array, etc. A data processing device of the first mate may only have unrestricted access to all features of the fishing vessel's sensing array. For example, the first mate may only be allowed to access the sensing array of the fishing vessel to: reorient a video camera device, initiate/halt operation of the video camera device, toggle operation of light emitting devices, etc. A data processing device of a deckhand may have restricted access (e.g. read-only, view-only, etc.) to the features of the fishing vessel's sensing array. For example, the deckhand may view sensor data (e.g. sensor temperature), sonar and/or video stream data generated by a video camera device of the sensing array.

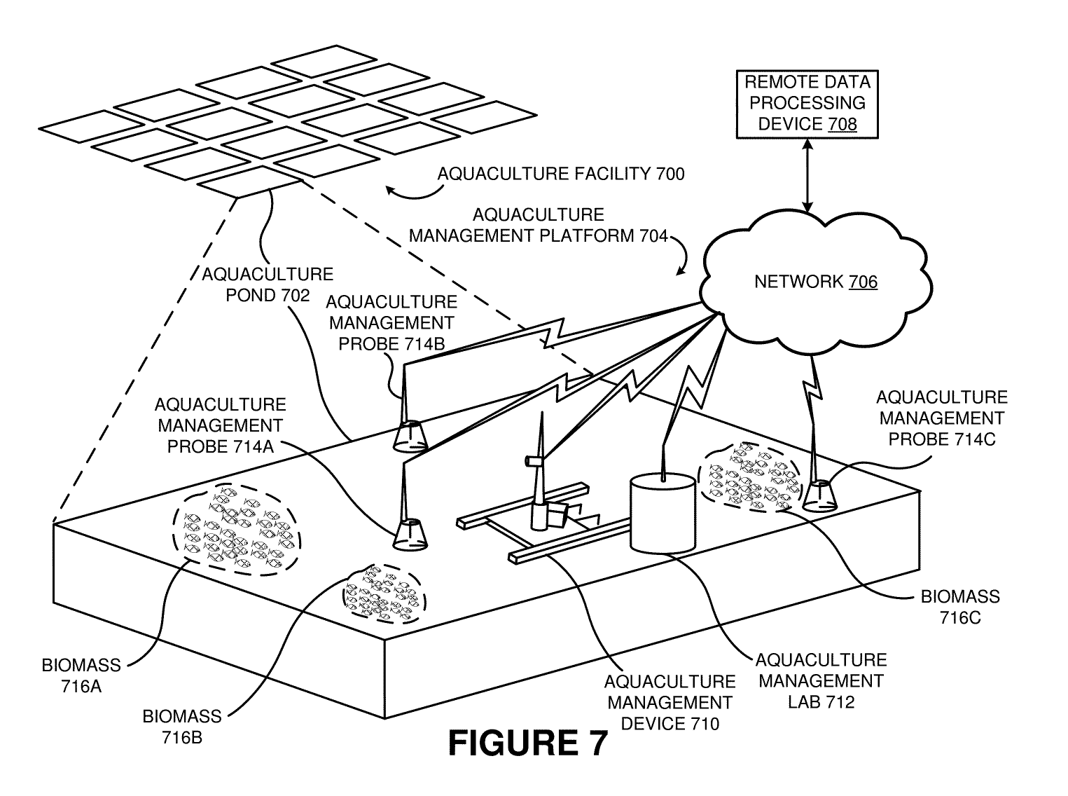

Reference is now made to FIG. 7, in which an aquaculture management platform and a device hierarchy thereof are illustrated, according to one or more embodiments. An aquaculture facility 700 may comprise one or more aquaculture pond 702. The aquaculture facility 700 may utilize an aquaculture management platform 704 (analogous to platform 100) to facilitate continuous operation, standards adherence, and environmental regulation of the aquaculture pond 702.

The aquaculture management platform 704 may comprise a plurality of aquaculture devices. The plurality of aquaculture devices may be communicatively coupled (e.g. through WiFi Direct™, Bluetooth, GPRS, etc.). The plurality of aquaculture devices may also establish a connection to a remote data processing device 708 through a network 706. The network connection may be established through an encrypted protocol or an unencrypted protocol. Furthermore, the aquaculture management platform 704 may provide a hierarchy of privilege-based access to the plurality of aquaculture devices and/or the remote data processing device 708.

For example, an aquaculture facility 700 may comprise a fishery owner, one or more operation managers, one or more fishery employees, a commerce partner, a standards quality officer (e.g. government-backed standards quality management organization), and/or other positions responsible for continuous operation and regulation of the aquaculture facility 700. Any of the abovementioned members of the aquaculture facility 700 may utilize the remote data processing device 708 and may be provided a degree of access to the aquaculture management platform 704.

The aquaculture facility 700 may utilize the aquaculture management platform 704 to facilitate continuous operation, standards adherence, and regulation of the aquaculture facility 700. An aquaculture management device (AMD) 710 may comprise one or more sensing arrays (e.g. an underwater sensing array and/or an above-surface sensing array). The AMD 710 may be utilized to manage the aquaculture pond 702 in the aquaculture facility 700. The AMD 710 may establish a connection to a network 706 (e.g. WWW, intranet, extranet) through GSM, WiFi™, satellite or other means.

The AMD 710 may also comprise a predator detection and deterrent system; material(s) dispenser; food delivery system; means for propulsion through water, mobility on land, and/or mobility through air; a power source (e.g. battery charged by solar cells and/or wind turbine); an on-board sample collection, processing, and analysis lab; a collision detection and avoidance system; global positioning system (GPS), etc. Other devices and/or modules of the AMD 710 that may facilitate the continuous operation, standards adherence, internal and/or external audit(s), and regulation needs of the aquaculture pond 702 are within the scope of the exemplary embodiments discussed herein.

In one embodiment, the AMD 710 may be a single device that may be used to manage the aquaculture pond 702. The AMD 710 may routinely or manually sample the aquaculture pond 702 for the purpose of analyzing the ecosystem of the aquaculture pond 702. For example, the degree of antibiotic use in the aquaculture pond 702 may be measured and reported by the AMD 710 through the network 706 to the remote data processing device 708. In another example, concentration of chemicals in the pond may be measured by the AMD 710 and reported to the remote data processing device 708 through network 706. In yet another example, a measurement of a biomass 714A-C may be routinely made during feeding. Such data may be useful in regulating the aquaculture pond 702, or may be submitted as evidence of standards adherence in response to compliance demands (e.g. by a government-backed standards quality management organization).

The AMD 710 may also be used for routine feeding of aquatic organisms through the food delivery systems of the AMD 710. In one embodiment, the food delivery system may be an onboard material(s) dispenser comprising a trap door and/or a conveyor for deployment of food. The food delivery system may operate based on an initial detection of optimal feeding conditions (e.g. optimal water pH for feeding, optimal breakdown of chemical concentrations in the water, etc.). In another embodiment, the food delivery system may be a barge communicatively coupled to the AMD 710. The barge may also comprise a material(s) dispenser as well as means for propulsion through water and mobility on land. The barge may be coupled to the AMD 710 through a wireless and/or a wired connection. The barge may have a dedicated power source (e.g. battery charged by solar cells and/or wind turbine) or may receive power from the AMD 710. Furthermore, the AMD 710 and/or the barge may re-charge at specific charging docks upon reaching a threshold battery level. The charging dock may recharge through conduction or through induction.

Furthermore, the AMD 710 may be utilized to prevent predators from disrupting the aquaculture pond 702. For example, the AMD 710 may detect a predator (e.g. birds, humans, etc.) through the predator detection system (e.g. motion detectors and object recognition system) and generate a report which may be submitted to the remote data processing device 708. Also, the AMD 710 may utilize the predator deterrent to deter the predator (e.g. flashing lights at humans, water cannon ejection, sound played through loudspeaker, report generated and communicated to devices in the network, etc.). The predator deterrent system may reduce loss of resources from the aquaculture facility 700 through theft or predation. In one embodiment, the predator deterrent system may utilize a strain gauge to detect undue strain on a net encompassing the aquaculture pond 702. Other methods of detecting predators in the aquaculture pond 702 are within the scope of the exemplary embodiments discussed herein.

Further yet, the AMD 710 may be the only device in operation in the aquaculture pond 702. The AMD 710 may operate according to three primary modes: automated by schedule, in which the AMD 710 performs certain tasks based on a predetermined schedule; automated by event, in which the AMD 710 performs certain tasks based on the occurrence and detection of specified events; and manual operation, in which operation of the AMD 710 can be assumed by the remote data processing device 708. The AMD 710 may be integral in measuring biomass 716A-C, especially during routine feeding. Biomass data may be used to regulate the population of brood stock in order to prevent overcrowding. Measurement of the biomass 716A-C may be facilitated by stereooptic video, laser measurement marking, and/or the sonar system of the AMD 710.

The AMD 710 may move between aquaculture ponds 702 in the aquaculture facility 700 through the means for propulsion through water, mobility on land, and mobility through air; the AMD 710 may subsequently generate separate reports for each aquaculture pond 702 and communicate the reports to the remote data processing device 708 through the network 706. The means for propulsion through water may comprise at least one outboard motor (e.g. coupled to a propeller) and/or at least one jet; the means for mobility on land may comprise continuous tracks on either side of the AMD 710; the means for mobility through air may be achieved by a propeller system coupled to the AMD 710. “Outboard” may describe any device as being coupled to a fishing vessel but situated and/or positioned outside of the hull thereof.

Other systems that may be used to facilitate the transport of the AMD 710 between ponds include the collision detection and avoidance system and the GPS. Through the utilization of the collision detection and avoidance system in concert with the GPS, the AMD 710 may map out the entire terrain of the aquaculture pond 702. As such, the AMD 710 may automatically transition from a patrol mode (movement along a trajectory) to an incident mode (e.g. through collision detection and avoidance, image recognition system, thermal sensor, etc.), generating geospatial data and storing the geo spatial data in a memory of the AMD 710. In the incident mode, if a positive identification of a predator or thief occurs, the AMD 710 may move towards the predator or thief and employ the predator deterrent system. Other systems that may be used to facilitate transport of the AMD 710 are within the scope of the exemplary embodiments discussed herein.

In another embodiment, the aquaculture management platform 704 may comprise a hierarchy of aquaculture devices ordered by complexity. For example, an aquaculture device at the top of the hierarchy (most complex) may be an aquaculture management lab (AML) 712. The AML 712 may be immobile or may have limited mobility but may provide all of the aforementioned features of the AMD 710 and any functions that may be necessary for proper management of the aquaculture facility 700. The AML 712 may comprise pathogen, antibiotic, and chemical detection and monitoring systems. Detection and interpretation of the degree of such materials in the aquaculture pond 702 may provide deeper insight into the condition of the aquaculture pond 702 and may indicate when action must be taken. For instance, a high concentration of antibiotics in the aquaculture pond 702 may contribute to an unsuitable marine environment and may indicate that action must be taken to regulate the marine environment and regain stability in antibiotic concentrations relative to governmental or organizational standards.

Lowest in the hierarchy may be an aquaculture management probe (AMP) 714. The AMP 714A-C may be limited-feature devices of smaller size than the AMD 710 and of relatively lower cost than the AMD 710. In one embodiment, a plurality of AMP 714A-C (e.g. with separate functions) may be distributed among a plurality of aquaculture ponds. For example, an AMP 714A may be specialized in pathogen detection, whereas an AMP 714B may be specialized in measuring a degree of antibiotic resistance. Furthermore, yet another AMP 714C may be specialized in measuring levels of chemicals in the aquaculture pond 702.

The middle of the hierarchy is the aforementioned AMD 710. However, when used in concert with the AML 712 and the AMP 714A-C, the AMD 710 may be used primarily for transportation between ponds for the purpose of performing sentry duties, passive monitoring, transmitting instructions, receiving data from the plurality of AMP 714A-C, and subsequently communicating the data to the AML 712. As such, the hierarchy of aquaculture devices may facilitate equipment and functionality scaling of the aquaculture management platform 704 to support the needs of each aquaculture facility 700. For example, a small-scale aquaculture environment having a relatively low number of ponds may require only a few AMP 714A-C and an AML 712. Alternatively, such a small-scale operation may benefit from a singular, roaming AMD 710. In another example, a large-scale aquaculture facility may wish to utilize every level of the hierarchy in order to generate high-resolution data (and therefore more precise and useful data) for the aquaculture facility 700.

Collectively, the AMP 714A-C, the AMD 710, and the AML 712 may constitute a network (e.g. intranet or extranet) of aquaculture devices that may be accessible by the remote data processing device 708 on a privileged basis. For example, a remote data processing device of the owner of the aquaculture facility 700 may be utilized to oversee all data and/or manipulate a component of the AMD 710, the AML 712, and the AMP 714A-C. The AMD 710, the AML 712, and the AMP 714A-C may passively monitor the environment of the aquaculture pond 702. Data gathered from the aquaculture pond 702 may include water metrics such pH, salinity, temperature, DO, nitrogen; number, type, and condition of organisms in the aquaculture pond 702; operational statuses of electronic devices and electromechanical devices of the AMD 710, the AML 712, and/or the AMP 714A-C; and other metrics that are instrumental in maintaining regular operation of the aquaculture pond 702.

Data gathered by the AMD 710, the AML 712, and/or the AMP 714A-C may be encrypted and transmitted securely through the network 706 to an onsite or cloud-based data vault, and/or to remote data processing device 708. Data gathered this way may be utilized to generate reports to be communicated to remote data processing device 708. Furthermore, the owner of the aquaculture facility 700 or a quality standards maintenance agent may also, for example, operate and/or change a position of the AMD 710, the AML 712, and/or the AMP 714A-C (e.g. to collect a water sample, position a video camera device for optimal viewing of biomass 716A-C, etc.).

The AMD 710, the AML 712, and/or the AMP 714A-C may require calibration in order to ensure precise measurements of environmental data. Such calibration may be automatically performed individually by the AMD 710, the AML 712, and/or the AMP 714A-C or performed by the quality standards maintenance agent.

Data gathered by the AMD 710, the AML 712, and/or the AMP 714A-C may be encrypted or unencrypted and may be transmitted to and stored in a secure cloud storage server and may be subject to a chain of custody that may be managed and/or monitored by the owner of the intranet/extranet of fishing vessels or the aquaculture facility 700. As such, access to the encrypted data may be controlled and individually provided to data processing devices of any member of a fishing crew or any node-locked (e.g. based on whitelisted MAC addresses at a predetermined relay point) data processing device of operation managers, fishery operators, commerce partners, members of maintenance crew, and any other parties interested in the encrypted data. Access to the encrypted data may involve decrypting the encrypted data by using a unique key (e.g. encoded in a non-volatile flash drive, encoded in a limited-use flash drive, generated through an authenticator, etc.). The unique key may be provided to individual data processing devices according to contractual obligation, government ordinance, etc. Additionally, data encryption and storage in the cloud storage server may also be provided according to contractual obligation, government ordinance, etc.

In either fishing environment (intranet of fishing vessels or aquaculture facility), sensor data may be communicated within the platform to enable real-time monitoring of all aspects of the fishing environment. For example, the owner of the fishing environment may wish to determine the content of the catch and more specifically, the type and/or size of organisms caught by harvesting devices in the fishing environment. The sensor data may be pivotal in determining possible supply chain routes through which the catch may be distributed. As such, the owner may improve return on investment (ROI) and the chances thereof, increase the efficiency of the fishing environment, and reduce the chance that the catch spoils due to long periods of time between catch and sale. In one example, a business operation may involve compiling data across multiple fishing environments to determine optimal catch conditions, predict overhead, determine optimal price for the catch, determine quota limits, etc. Other uses of the data for the purpose of facilitating business and/or commerce are within the scope of the exemplary embodiments discussed herein.

A fishing environment may be subject to government oversight in order to continuously ensure compliance with regulations. In a wild catch fishing environment, the owner of a fishing vessel (or a plurality of fishing vessels) may be obligated to provide for the safety, boarding, and hospitality of a government-authorized inspector. The inspector may determine if certain aspects of the fishing vessel operation do not meet compliance requirements (e.g. endangered species are not caught, catch does not exceed a certain amount, or catch contains a certain amount of out-of-season species, etc.). Such costs may be required for all operators of fishing vessels but may be prohibitively expensive. Alternatively, such costs may be cut by providing the inspector remote access to the platform. As such, the inspector may have read-only access to data and metadata stored securely in the secure cloud storage. Furthermore, the inspector may have real-time read access to video camera devices and other sensors tied to the platform. Subsequently, the inspector may issue an encrypted compliance report to the owner through the platform, whereby the compliance report lists any regulation, compliance, or standards issues observed by the inspector.

An owner of the aquaculture facility 700 operation may be obligated to permit a government-authorized inspector access to analyze certain aspects of the aquaculture facility 700 to determine if compliance requirements are met (e.g. marine living conditions are optimal (e.g. stable chemical concentrations, antibiotic levels, feeding routines are sufficient and at the right frequency, etc.), groundwater waste is limited, population growth is controlled, etc.). Such costs may be required for each pond in the aquaculture facility 700 and as such, scaling may be prohibitively expensive due to strict compliance constraints. Alternatively, such costs may be reduced by providing the inspector remote access to the aquaculture management platform 704. As such, the remote data processing device 708 of the inspector may be provided read-only access to data and metadata stored securely in the secure cloud storage. Furthermore, the inspector may have real-time access to video camera devices and other sensors tied to the aquaculture management platform 704. Subsequently, the inspector may issue an encrypted compliance report to the owner through the aquaculture management platform 704, whereby the compliance report lists any regulation, compliance, or standards issues observed by the inspector. The inspector may alternately be given read/write access to the aquaculture management platform 704. In emergency cases, the inspector may be able shut down the aquaculture facility 700, release a catch from a trawl net, etc.

Reference is now made to FIGS. 5A-E, which are schematic diagrams that illustrate different embodiments of the sensing array with respect to the underwater harvesting device. FIG. 5A is a schematic diagram of a sensing array 500 monitoring a seine net 502, according to one or more embodiments. FIG. 5B is a schematic diagram of a sensing array 510 monitoring a fishing pot 512, according to one or more embodiments. FIG. 5C is a schematic diagram of a sensing array 520 mounted to the anterior of the catch end of the trawl net 522, similar to the exemplary embodiments of the sensing array 202 as shown in FIG. 2 and FIG. 3.

FIG. 5D is a schematic diagram of a sensing array 530 mounted to a remotely operated vehicle (ROV) 534. The sensing array 530 may monitor a seine net 532 coupled to the fishing vessel 208. The ROV 534 may operate autonomously and/or may be manually operated by the data processing device onboard the fishing vessel 208 or by a remote data processing device. In one embodiment, the sensing array 530 may be coupled to marker buoy 536 which is in turn coupled to the seine net 532. The sensing array 530 may be mounted directly to the marker buoy 536 or may be tethered to the marker buoy 536. The marker buoy 536 may be communicatively coupled to a data processing device aboard the fishing vessel 208. As such, a control signal may be transmitted from the data processing device aboard the fishing vessel 208 to the marker buoy 536 through a wireless bridge 538. The control signal may be subsequently transmitted from the marker buoy 536 to the sensing array 530 through an umbilical tether 539 (e.g. wired and/or wireless). The marker buoy 536 may also serve to keep a terminal end of the seine net 532 in place during deployment of the seine net 532 by the fishing vessel 208.

In another embodiment, a terminal end 537 of the seine net 532 may be coupled to a skiff to which the sensing array 530 may be communicatively coupled. Similarly to the previous embodiment, the sensing array 530 may be mounted directly to the skiff or may be communicatively coupled to the skiff through the umbilical tether 539. As such, the skiff may relay data to the data processing device of the fishing vessel 208 through the wireless bridge 538. The skiff may also serve to aid in deployment of the seine net 532.

In yet another embodiment, the cork line of the seine net 532 may comprise an embedded umbilical cable, originating from the fishing vessel 208. The umbilical cable may span the length of the cork line or any portion thereof and may facilitate bidirectional communication between the data processing device of the fishing vessel 208 and at least one sensing array 530 coupled to the seine net 532. The use of a plurality of sensing arrays may provide more high resolution data of the contents of the seine net 502.

FIG. 5E is a schematic diagram of a plurality of sensing arrays (collectively named a sensing array swarm 540) coupled to a trawl net 542. The sensing array swarm 540 may comprise individual lightweight versions of the sensing array 202. The sensing array swarm 540 may serve to provide multiple viewing angles into the trawl net 542.

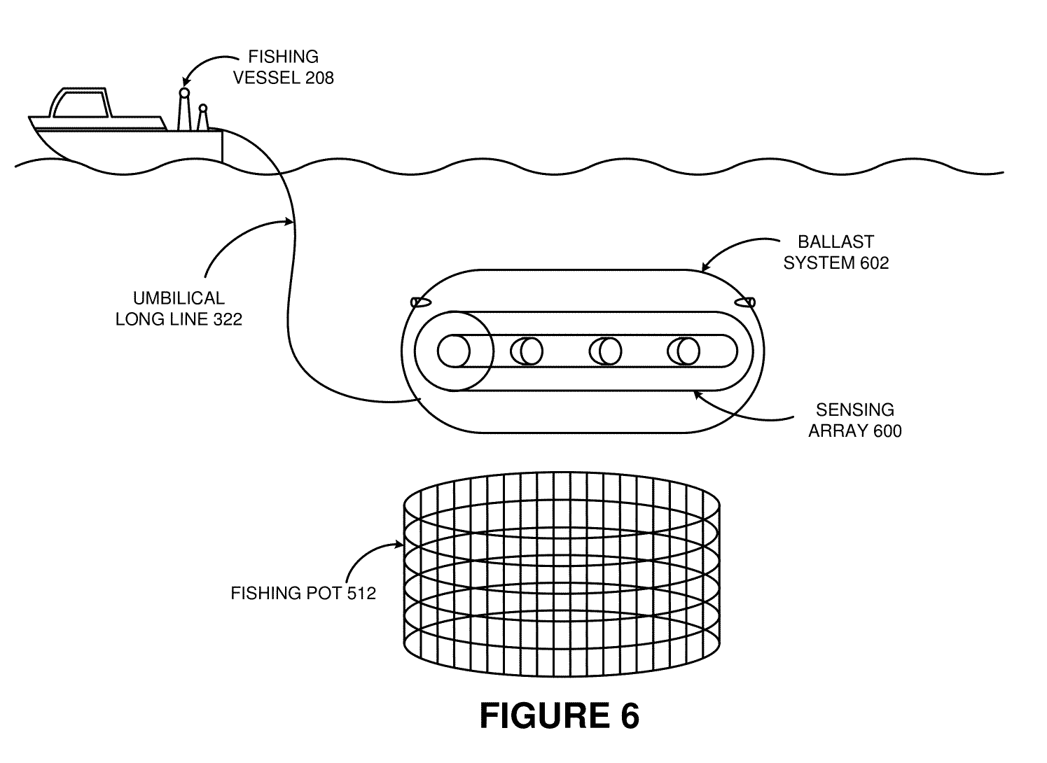

FIG. 6 is a schematic diagram of a sensing array coupled to a ballast jacket system. A sensing array 600 may be coupled to a ballast system 602 and may be deployed to monitor a harvesting device, such as a fishing pot 512 as shown in FIG. 6. Other harvesting methods may be monitored by the sensing array 600 and may be within the scope of the exemplary embodiments discussed herein. The sensing array 600 may communicate with a data processing device of the fishing vessel 208 and may receive a control signal from the data processing device and subsequently transmit the control signal to the ballast system 602.

The ballast system 602 may comprise a propulsion system (e.g. an array of propulsion jets) for movement within marine environments. Upon detection of a buoy line, the sensing array 600 may be sunk down and optimally positioned or remote monitoring of the fishing pot 512. The ballast system 602 may be remotely controlled through the data processing device of the fishing vessel 208. As such, a control signal may be transmitted to the ballast system 602 to resurface the entire apparatus (the sensing array 600 and the ballast system 602).

In one or more embodiments, a sensing array may be a tracking device. The tracking device may be deployed (at the fishing environment site) into a collection bin containing a fresh catch. Upon deployment, the tracking device may begin monitoring and recording of a plurality of key environmental aspects, thus generating a “dynamic electronic” manifest for the catch during transportation. Key environmental aspects may comprise GPS tracking, temperature, sudden changes in light and/or sound, sudden movements (e.g. through an accelerometer), etc. Other key environmental aspects that may be tracked are within the scope of the exemplary embodiments discussed herein.

The tracking device may be supported by the platform 100 and may be able to transmit tracked data to the server 102 and/or the data processing device 103 through the network 101. Upon contact with the network 101 by the tracking device (e.g. through GSM, WiFi™, or other wireless communication system), the tracked data may be encrypted and transmitted to the server 102 and/or the data processing device 103 and/or through an encrypted channel to be stored in a cloud storage server. The tracked data may be decrypted using a unique key. Subsequently, the owner of the fishing environment may validate the dynamic electronic manifest and reset the tracking device for future use.

In one embodiment, the fishing vessel 208 may be a front-sweeping harvester (FSH). Such a vessel may harvest through a net mounted to the anterior end of the FSH. As such, harvesting takes place during forward movement of the fishing vessel. The FSH may comprise at least one sensing array (e.g. above water and under water) and may be manually operated (manned or remotely operated) or may operate autonomously. Similarly to the AMD 710, the FSH may comprise a plurality of sensors that may be used to generate data based on measurements of environmental variables. In one embodiment, the barge coupled to the AMD 710 may be a FSH and may additionally store a catch in a tow pen of the FSH.

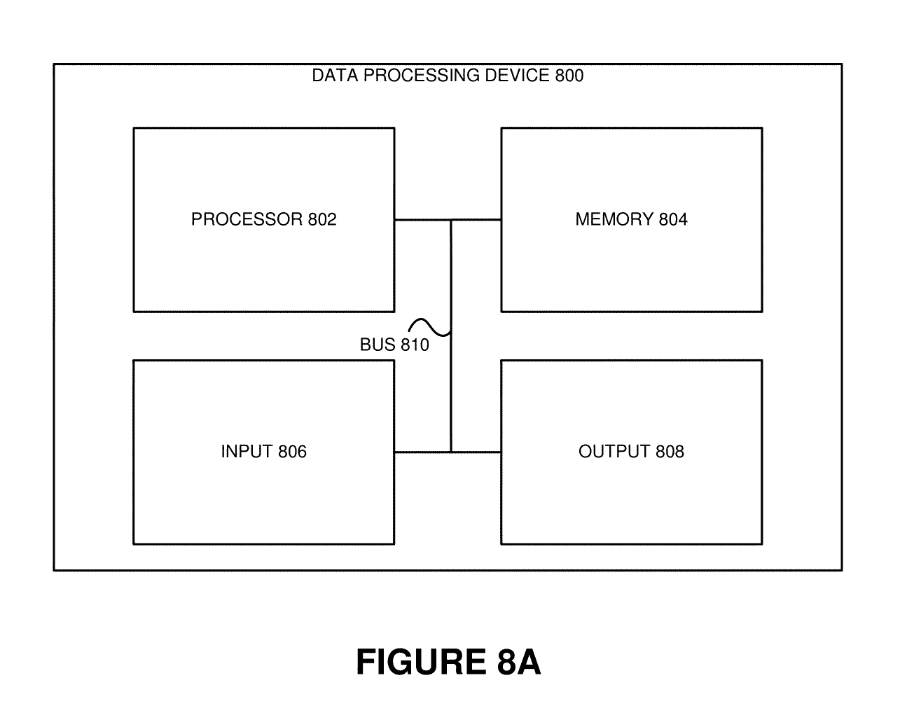

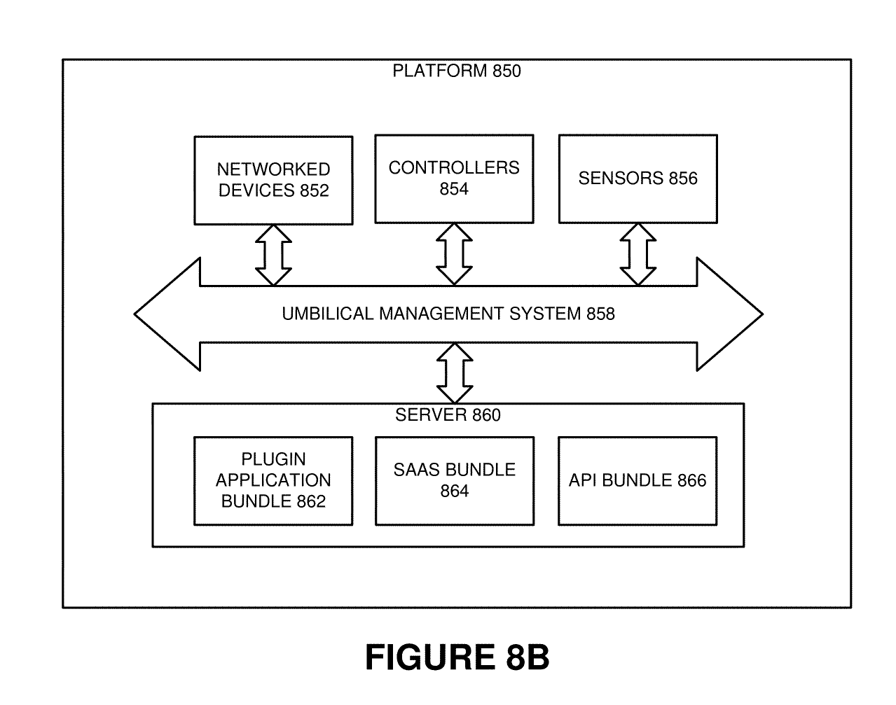

FIG. 8A shows a structure of a data processing device 800 such as may be used in the system of FIG. 2, according to one or more embodiments. Data processing device 800 may be a rich client device, such as a desktop, laptop, notebook, server, network computer, or any computing device capable of independent operation. Alternatively, a data processing device may be a thin client device, such as a smartphone, tablet, Chromebook®, or any computing device that may depend to some degree on another data processing device to fulfill its computational capabilities. The data processing device 800 may be a standalone device or a network of devices communicatively coupled through a wired or wireless connection. The data processing device 800 may include a processor 802 for executing software instructions, a memory 804, an input 806, and an output 808. Such components may be coupled through a bus 810.

FIG. 8B shows a structure of a platform 850 such as may be used in the platform of FIG. 1, according to one or embodiments. The platform 850 may be a computing environment comprising hardware that may facilitate the execution of software. The platform 850 may comprise an umbilical management system 858 that may facilitate communications between: one or more networked devices 852, one or more controllers 854, one or more sensors 856, and a server 860. The server 860 may comprise a plugin application 862, a SaaS bundle 864, and an API bundle 866. The plugin application 862, the SaaS bundle 864, and the API bundle 866 may be provided to the networked devices 852 to facilitate operation of software and/or hardware of the networked devices and devices coupled thereto within a fishing environment.

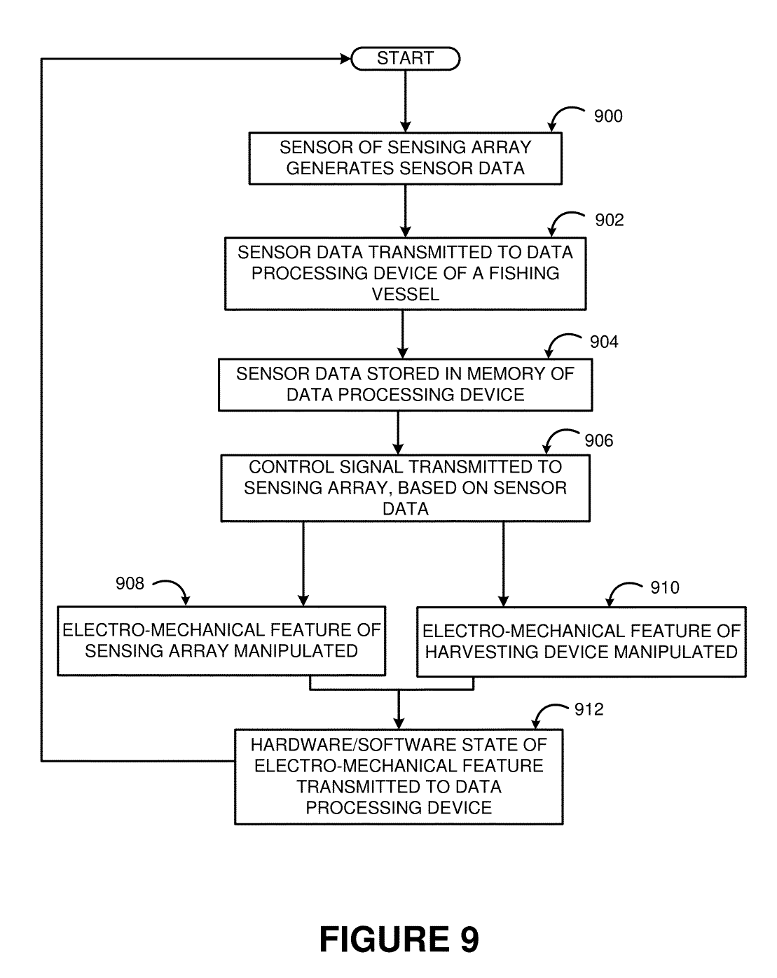

FIG. 9 is a process flow chart of a feedback system involving monitoring of an underwater harvesting device and manipulating one or more electro-mechanical features of an underwater sensing array and/or an underwater harvesting device, according to one or more embodiments. In operation 900, a sensor of an underwater sensing array generates sensor data. In operation 902, the sensor data is transmitted to a data processing device of a fishing vessel coupled to the underwater harvesting device. Operation 904 involves storing the sensor data in a memory of the data processing device. Operation 906 involves transmitting a control signal to the sensing array based on the sensor data. In operation 908, an electro-mechanical feature of the sensing array is manipulated. Alternatively, in operation 910, an electro-mechanical feature of the underwater harvesting device is manipulated. Operation 912 involves transmitting the hardware/software state of the electromechanical feature to the data processing device.

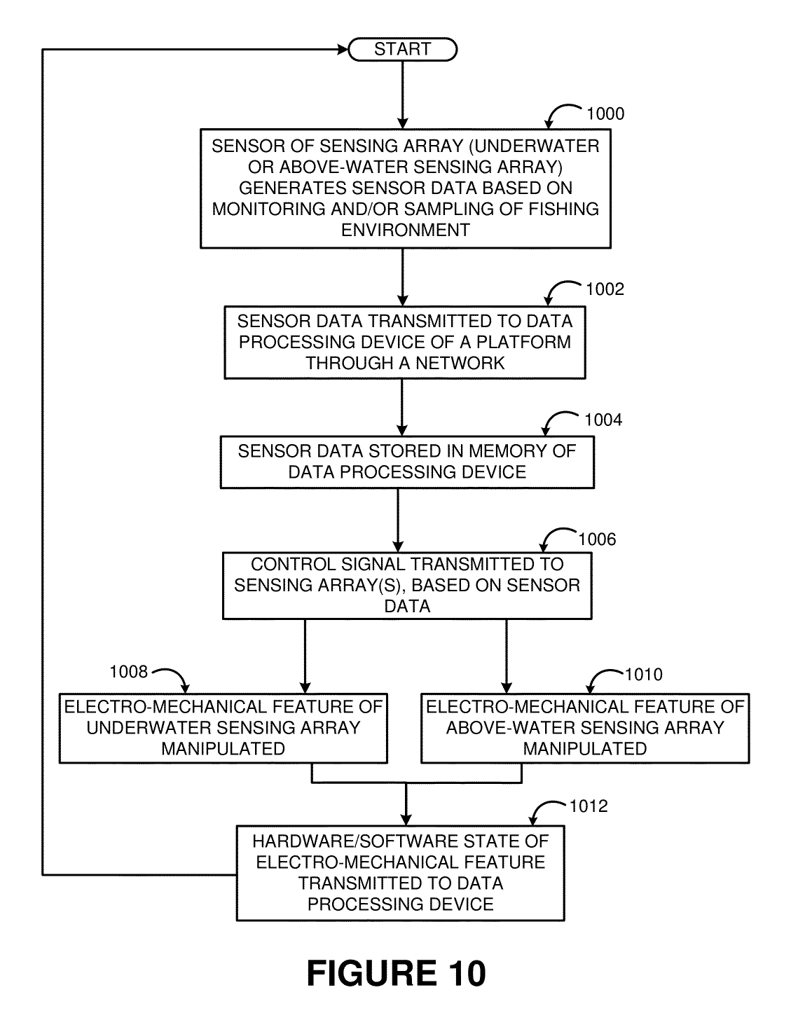

FIG. 10 is a process flow chart of a feedback system involving monitoring and sampling a fishing environment and manipulating one or more electro-mechanical features of an underwater or above-water sensing array, according to one or more embodiments. In operation 1000, a sensor of a sensing array (underwater sensing array or above-water sensing array) generates sensor data based on monitoring and/or sampling of a fishing environment. Operation 1002 involves transmitting the sensor data to a data processing device of a platform through a network. Operation 1004 involves storing the sensor data in a memory of the data processing device. Operation 1006 involves transmitting a control signal to the sensing array(s) based on the sensor data. Operation 1008 involves manipulating an electro-mechanical feature of the underwater sensing array, if applicable. Operation 1010 involves manipulating an electro-mechanical feature of the above-water sensing array, if applicable. Operation 1012 involves transmitting the hardware/software state of the electro-mechanical feature to the data processing device.

What is claimed is:

1. A fishing system comprising:
a sensing array comprising one or more sensors, the one or more sensors configured to generate sensor data pertaining to one or more environmental characteristics associated with a fishing environment;
one or more electronic devices coupled to the sensing array;
one or more electromechanical devices coupled to the sensing array; and
a bidirectional communication subsystem to:
transmit the sensor data from the sensing array to a memory of a data processing device, and
transmit, based on the sensor data, a control signal from the data processing device to the sensing array to manipulate one or more features associated with at least one of the one or more electronic devices and the one or more electromechanical devices.

2. The fishing system of claim 1, further comprising an underwater harvesting device associated with the sensing array, wherein the sensing array generates sensor data pertaining to one or more characteristics associated with the underwater harvesting device.

3. The fishing system of claim 1, wherein the sensing array is mounted to at least one of: a remotely operated vehicle and an autonomous underwater vehicle.

4. The fishing system of claim 1, wherein the sensing array further comprises a remotely controllable ballast system configured to control, through a control signal transmitted from the data processing device, a depth of the sensing array.

5. The fishing system of claim 2, wherein the sensing array is mounted to the underwater harvesting device.

6. The fishing system of claim 1, wherein the sensing array is communicatively coupled to the data processing device through at least one of: a wireless connection and a wired connection.

7. A method of precision fishing comprising:
generating sensor data through one or more sensors of a sensing array associated with a fishing environment,
wherein the sensor data pertains to one or more environmental characteristics of the fishing environment;
transmitting the sensor data from the sensing array to a data processing device communicatively coupled to the sensing array through a bidirectional communication subsystem;
storing the sensor data in a memory of the data processing device; and
transmitting, based on the sensor data, a control signal through the bidirectional communication subsystem to a controller of the sensing array to manipulate a feature of at least one of: the one or more sensors, one or more electronic devices coupled to the controller, and one or more electromechanical devices coupled to the controller,
wherein the one or more electronic devices and the one or more electromechanical devices are associated with the fishing environment.

8. The method of claim 7, further comprising:
controlling a depth and a horizontal position of the sensing array through a control signal transmitted from the data processing device to a remotely controllable ballast system coupled to the sensing array.

9. The method of claim 7, further comprising:
polling at least one of: the sensing array, the data processing device, and the bidirectional communication subsystem; and
determining, based on the polling, one or more operational statuses of at least one of: the sensing array, the data processing device, the bidirectional communication subsystem.

10. The method of claim 7, further comprising:
establishing a connection through an internet protocol between the data processing device and at least one of: the World Wide Web and an intranet; and
transmitting the sensor data via the established connection to a remote data processing device,
wherein the established connection is encrypted and permits privilege-based access.

11. The method of claim 7, further comprising appending descriptive metadata to the sensor data.

12. The method of claim 7, wherein the sensing array is mounted to at least one of: a remotely operated vehicle and an autonomous underwater vehicle.

13. The method of claim 7, wherein the sensing array are communicatively coupled to the data processing device through at least one of: a wireless means and a wired means.

14. A platform for precision fishing comprising:
a data processing device comprising:
a memory;
a processor configured to execute an operating system for:
facilitating a plugin application bundle and a service-as-a-software (SaaS) bundle, and
supporting an application programming interface (API) bundle;
one or more controllers communicatively coupled to the data processing device and configured to enable bidirectional transmission of data, through one or more control protocols, between one or more electromechanical devices and the processor,
wherein the one or more electromechanical devices are:
communicatively coupled to the processor through a plug-in interface of the one or more controllers, and
associated with a fishing environment; and
one or more sensors communicatively coupled to the processor through the plug-in interface of the data processing device,
wherein the one or more sensors generate sensor data pertaining to one or more environmental characteristics of the fishing environment.

15. The platform of claim 14, further comprising:
a hardware translational interface having one or more hardware adapters coupled to the one or more controllers, configured to enable communicative coupling of one or more third-party devices to the one or more controllers,
wherein the processor is further configured to execute one or more software component adapters to support the use of third-party software, allowing compatibility support for the one or more third-party devices.

16. The platform of claim 14, further comprising:
a hardware translational interface having one or more hardware adapters coupled to the data processing device, enabling communicative coupling of one or more third-party sensors to the data processing device,
wherein the processor is further configured to execute one or more software component adapters to support the use of third-party software, allowing compatibility support for the one or more third-party sensors.

17. The platform of claim 14, further comprising at least one of a cellular antenna and a satellite dish to establish a connection to at least one of: the World Wide Web and an intranet.

18. The platform of claim 17, wherein the processor of the data processing device is further configured to execute instructions to:
transmit the sensor data via the established connection to a remote data processing device,
wherein the established connection is encrypted and permits privilege-based access to the sensor data.

19. The platform of claim 14, wherein the data processing device is communicatively coupled to the one or more controllers through at least one of: a wireless means and a wired means.
